(19) United States
(12) Patent Application Publication
(10) Pub. No.: US 2019/0256775 A1
(43) Pub. Date: Aug. 22, 2019

(54) LIQUID CRYSTAL COMPOSITION, LIQUID CRYSTAL DISPLAY ELEMENT AND LIQUID CRYSTAL DISPLAY

(71) Applicant: Shijiazhuang Chengzhi Yonghua Display Material Co., Ltd., Hebei (CN)

(72) Inventors: Mingxia WANG, Hebei (CN); Hongmei CUI, Hebei (CN); Yiping WANG, Hebei (CN); Sumin KANG, Hebei (CN)

(21) Appl. No.: 16/398,062

(22) Filed: Apr. 29, 2019

(30) Foreign Application Priority Data
May 18, 2018 (CN) 201810481579.6

(51) Int. Cl. C09K 19/34

(52) U.S. Cl. CPC C09K 19/3491; C09K 2019/0466

(57) ABSTRACT

The present invention relates to a liquid crystal composition, a liquid crystal display element, and a liquid crystal display. Said liquid crystal composition comprises one or more compounds represented by formula I, one or more compounds represented by formula II, and one or more compounds represented by formula III: R₁, R₂, R₃ and R₄ each independently represent an alkyl group having a carbon atom number of 1-10, a fluorine-substituted alkyl group having a carbon atom number of 1-10, an alkoxy group having a carbon atom number of 1-10, a fluorine-substituted alkoxy group having a carbon atom number of 1-10, an alkenyl group having a carbon atom number of 2-10, a fluorine-substituted alkenyl group having a carbon atom number of 2-10, an alkenoxy group having a carbon atom number of 3-8 or an fluorine-substituted alkenoxy group having a carbon atom number of 3-8; R and R′ represent cyclopropyl, cyclopentyl or 2-tetrahydrofuranyl; and rings A and B each independently represent 1,4-phenylene or 1,4-cyclohexylene. Said liquid crystal composition is particularly suitable for use in active matrix displays, in particular for use in displays based on a VA, PSA, PA-VA, SS-VA, SA-VA, PS-VA, PALC, IPS, PS-IPS, FFS or PS-FFS effect.

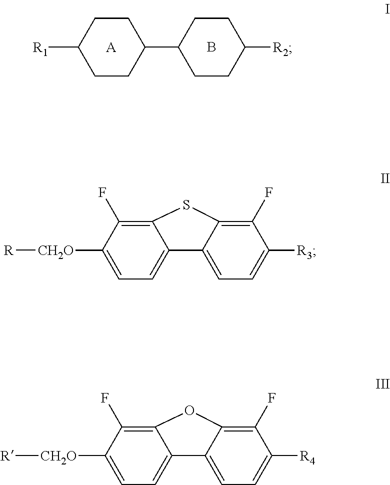

### TECHNICAL FIELD

The present invention relates to the field of liquid crystal displays. More particularly, the present invention relates to a liquid crystal composition, and a liquid crystal display element or liquid crystal display comprising the liquid crystal composition.

### BACKGROUND ART

At present, the expansion of application range of liquid crystal compounds becomes larger and larger, and the liquid crystal compounds can be used in various types of displays, electro-optical devices, sensors, etc. There are a wide variety of liquid crystal compounds for use in the above-mentioned display field, wherein nematic phase liquid crystals are the most widely applied. Nematic phase liquid crystals have been used in passive TN and STN matrix displays and systems having a TFT active matrix.

For the field of thin film transistor technology (TFT-LCD) applications, although the market has become very large in recent years, and the technologies have gradually matured, the requirements for display technologies are also constantly raising, especially in terms of achieving a fast response, reducing the drive voltage to reduce power consumption, etc. As one of the important optoelectronic materials for liquid crystal displays, liquid crystal materials play an important role in improving the performance of liquid crystal displays.

As liquid crystal materials, they are required to have a good chemical and thermal stability as well as stability to electric fields and electromagnetic radiation. In addition, as a liquid crystal material for thin film transistor technology (TFT-LCD), it is not only required to have the above-mentioned stability, but should also have the properties of a wider nematic phase temperature range, a suitable birefringence anisotropy, a very high resistivity, and a good ultraviolet resistance, a high charge retention ratio, a low vapor pressure, etc.

For dynamic picture display applications, to eliminate afterimage and trailing in picture displaying, the liquid crystal is required to have a fast response speed, and is thus required to have a lower rotary viscosity γ₁; in addition, for portable devices, in order to reduce the energy consumption of the device, it is desirable that the drive voltage of the liquid crystal is as low as possible; and for displays for use in televisions etc., the requirements for the drive voltage of the liquid crystal are not that low.

The viscosity, especially rotary viscosity γ₁, of a liquid crystal compound directly affects the response time after the liquid crystal is energized; regardless of whether the rise time (tₒₙ) or the fall time (t_{off}), they are both directly proportional to the rotary viscosity γ₁ of the liquid crystal, wherein since the rise time (tₒₙ) is related to the liquid crystal cell and the drive voltage, it can be adjusted by increasing the drive voltage and reducing the thickness of the liquid crystal cell; however, the fall time (t_{off}) is independent of the drive voltage, and is mainly related to the elastic constant of the liquid crystal and the thickness of the liquid crystal cell, and thinning the cell thickness will reduce the fall time (t_{off}); furthermore, the movement of liquid crystal molecules varies with the display mode, and the three modes of TN, IPS, and VA are inversely proportional to the average elastic constant K, the twist elastic constant, and the bending elastic constant.

According to the theory of liquid crystal continuum, different kinds of liquid crystals will “rebound” back to the original shape by means of the interaction between molecules after being deformed under the action of external forces (electric fields, and magnetic fields); likewise, liquid crystals also form a “viscosity” due to the intermolecular force. Small changes in liquid crystal molecules may cause significant changes in the conventional parameters and properties of liquid crystals, among which some changes are regular, and some seem to have difficulty in finding rules; and there may also be significant effects on the interaction between liquid crystal molecules, these effects are very subtle, and no perfect theoretical explanations have yet been formed.

The viscosity of the liquid crystal is related to the molecular structure of the liquid crystal, and it is one of the important tasks of liquid crystal formulation engineers to study the relationship between the viscosity of liquid crystal systems formed from different liquid crystal molecules and the molecular structures of the liquid crystal molecules.

The reason for an LCD panel having a high energy consumption is that only about 5% of the backlight can penetrate the display device and is captured by the human eyes, and most of the light is “wasted”.

### SUMMARY OF THE INVENTION

The technical problem to be solved by the present invention is to provide a liquid crystal composition, which has a good stability to light and heat and a lower viscosity, and can achieve a relatively wide refractive index and a high clearing point (a very wide service temperature range), and in particular, to provide a liquid crystal composition having a higher light transmittance, and a liquid crystal display element or liquid crystal display having a higher brightness or an effect of saving energy and electricity.

In one aspect, the present invention provides a liquid crystal composition comprising one or more compounds represented by formula I, one or more compounds represented by formula II, and one or more compounds represented by formula III:

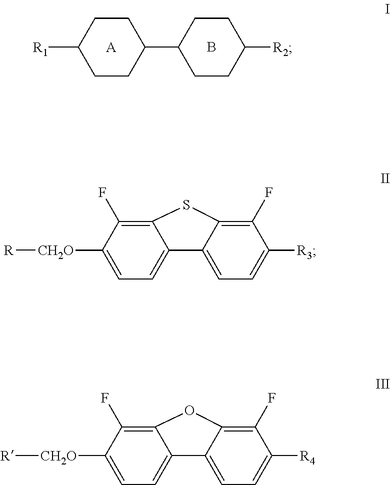

R₁, R₂, R₃ and R₄ each independently represent an alkyl group having a carbon atom number of 1-10, a fluorine-substituted alkyl group having a carbon atom number of 1-10, an alkoxy group having a carbon atom number of 1-10, a fluorine-substituted alkoxy group having a carbon atom number of 1-10, an alkenyl group having a carbon atom number of 2-10, a fluorine-substituted alkenyl group having a carbon atom number of 2-10, an alkenoxy group having a carbon atom number of 3-8 or an fluorine-substituted alkenoxy group having a carbon atom number of 3-8;

R represents cyclopropyl, cyclopentyl or 2-tetrahydrofuranyl; and

rings A and B each independently represent 1,4-phenylene or 1,4-cyclohexylene.

In one aspect, in one embodiment of the liquid crystal composition of the present invention, the above-mentioned one or more compounds represented by formula I are selected from compounds represented by formulas I-1 to I-17 below, the above-mentioned one or more compounds represented by formula II are selected from compounds represented by formulas II-1 to II-3 below, and the above-mentioned one or more compounds represented by formula III are selected from compounds represented by formulas III-1 to III-3 below:

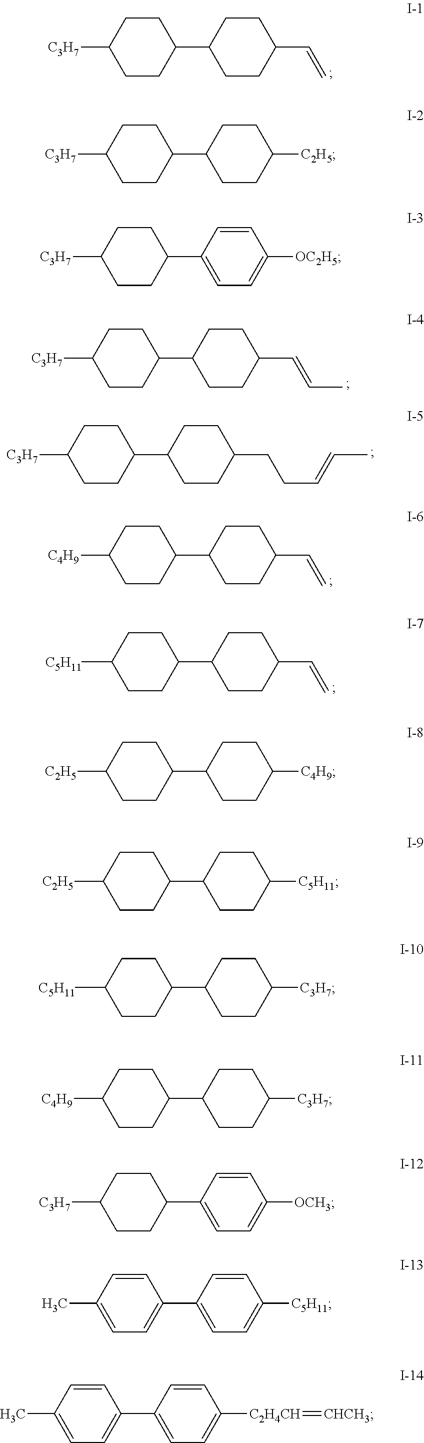

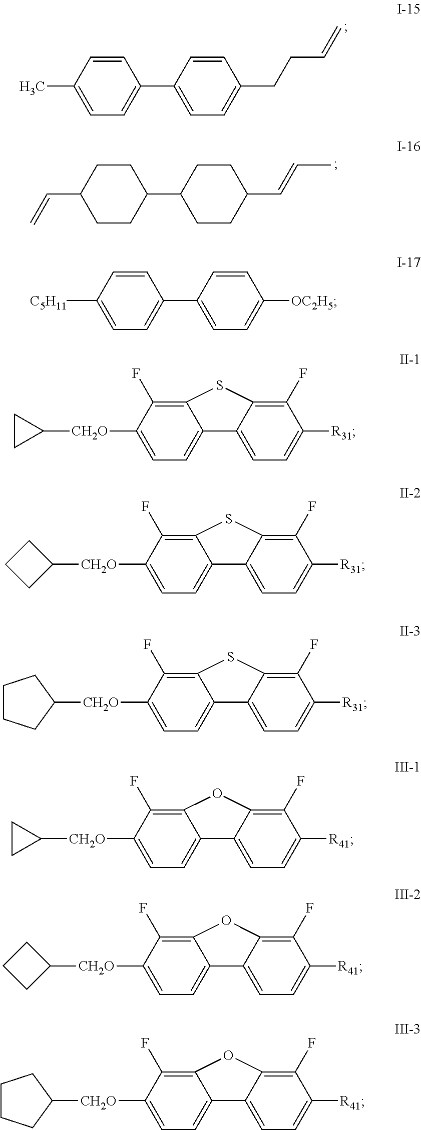

wherein

in formulas II-1 to II-3, R₃₁ represents an alkyl group having a carbon atom number of 1-10 or an alkoxy group; and

in formulas III-1 to III-3, R₄₁ represents an alkyl group having a carbon atom number of 1-10 or an alkoxy group.

In one aspect, in one embodiment of the liquid crystal composition of the present invention, the above-mentioned one or more compounds represented by formula I are selected from compounds represented by formulas I-1, I-2, I-4, I-7, I-9, I-10, I-11, and I-13 below, the above-mentioned one or more compounds represented by formula II are selected from compounds represented by formulas II-1 and II-3 below, and the above-mentioned one or more compounds represented by formula III are one or more selected from compounds represented by formulas III-1 and III-3 below:

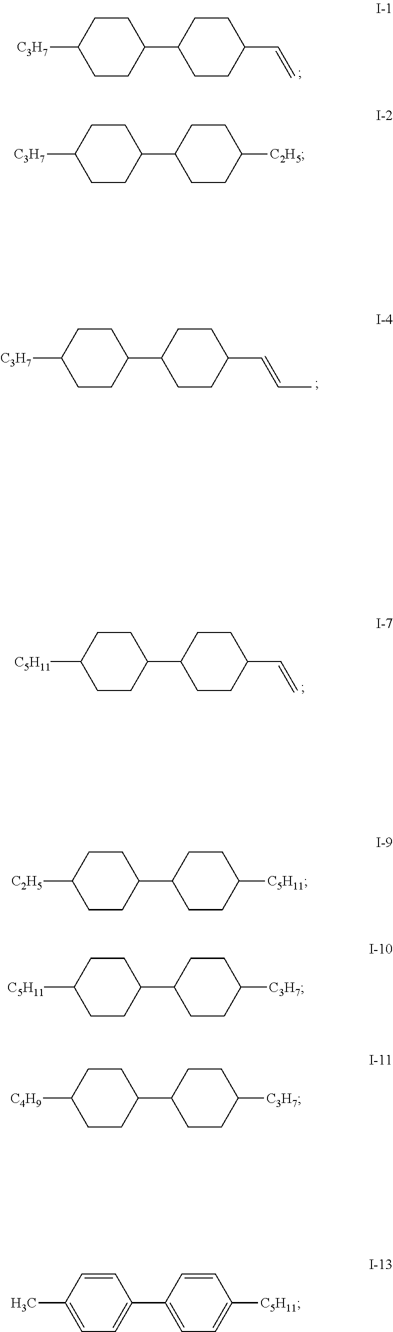

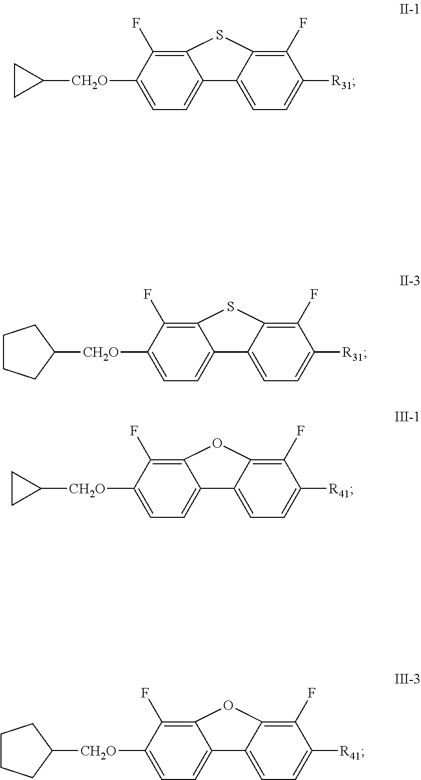

wherein in formulas II-1 and II-3, R₃₁ represents an alkyl group having a carbon atom number of 1-10 or an alkoxy group having a carbon atom number of 1-10; and

in formulas III-1 and III-3, R₄₁ represents an alkyl group having a carbon atom number of 1-10 or an alkoxy group having a carbon atom number of 1-10.

In one aspect, in one embodiment of the liquid crystal composition of the present invention, the total content of the above-mentioned one or more compounds represented by formula I is from 5%-70% by mass, the total content of the above-mentioned one or more compounds represented by formula II is from 1%-15% by mass, and the total content of the above-mentioned one or more compounds represented by formula III is 1%-15% by mass.

In one aspect, in one embodiment of the liquid crystal composition of the present invention, the total content of the above-mentioned one or more compounds represented by formula I is from 20%-60% by mass, the total content of the above-mentioned one or more compounds represented by formula II is from 1%-6% by mass, and the total content of the above-mentioned one or more compounds represented by formula III is 1%-6% by mass.

In one aspect, in one embodiment of the liquid crystal composition of the present invention, the liquid crystal composition comprises one or more compounds represented by general formula IV:

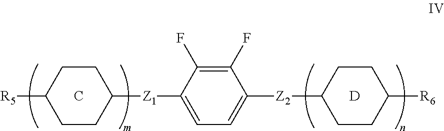

wherein R₅ and R₆ each independently represent an alkyl group having a carbon atom number of 1-10, fluorine, a fluorine-substituted alkyl group having a carbon atom number of 1-10, an alkoxy group having a carbon atom number of 1-10, a fluorine-substituted alkoxy group having a carbon atom number of 1-10, an alkenyl group having a carbon atom number of 2-10, a fluorine-substituted alkenyl group having a carbon atom number of 2-10, an alkenoxy group having a carbon atom number of 3-8 or an fluorine-substituted alkenoxy group having a carbon atom number of 3-8, wherein any one or more CH₂ in the groups represented by R₅ and R₆ is optionally replaced by cyclopentyl, cyclobutyl or cyclopropyl;

Z₁ and Z₂ each independently represent a single bond, —CH₂CH₂— or —CH₂O—;

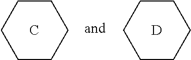

each independently represent

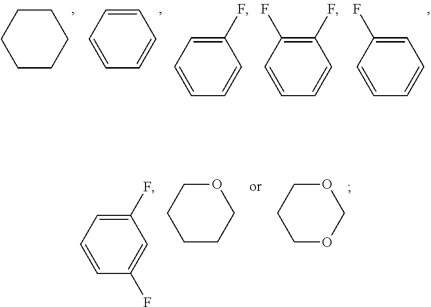

m represents 1, 2 or 3; and

n represents 0 or 1.

In one aspect, in one embodiment of the liquid crystal composition of the present invention, the above-mentioned one or more compounds represented by formula IV are selected from the group consisting of compounds represented by formulas IV1 to IV13:

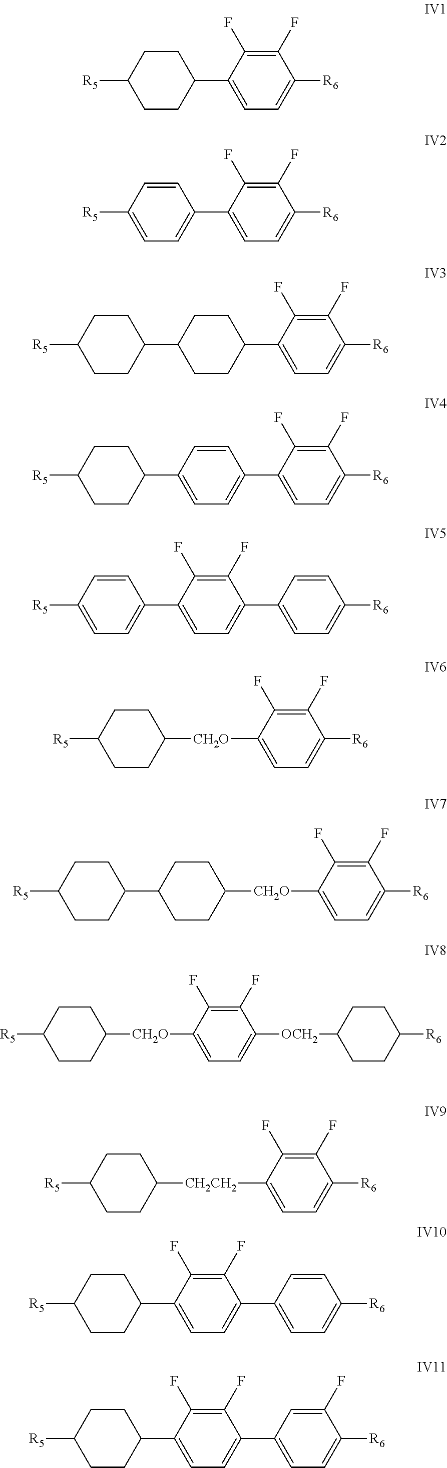

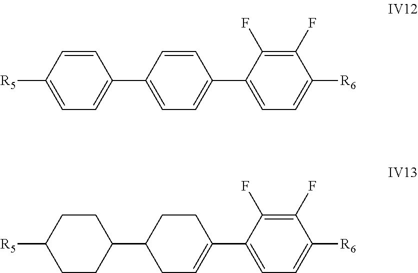

wherein R₅ and R₆ each independently represent an alkyl group having a carbon atom number of 1-10, fluorine, a fluorine-substituted alkyl group having a carbon atom number of 1-10, an alkoxy group having a carbon atom number of 1-10, a fluorine-substituted alkoxy group having a carbon atom number of 1-10, an alkenyl group having a carbon atom number of 2-10, a fluorine-substituted alkenyl group having a carbon atom number of 2-10, an alkenoxy group having a carbon atom number of 3-8 or an fluorine-substituted alkenoxy group having a carbon atom number of 3-8, wherein any one or more CH₂ in the groups represented by R₅ and R₆ is optionally replaced by cyclopentyl, cyclobutyl or cyclopropyl.

In one aspect, in one embodiment of the liquid crystal composition of the present invention, the above-mentioned one or more compounds represented by formula IV are selected from the group consisting of compounds represented by formulas IV1 to IV7, IV12 and IV13:

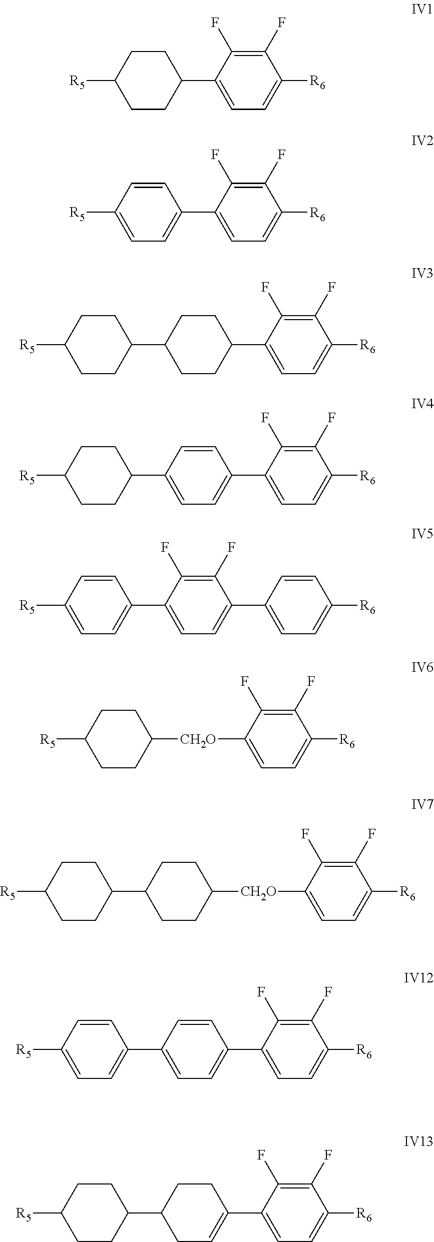

wherein R₅ and R₆ each independently represent an alkyl group having a carbon atom number of 1-10, fluorine, a fluorine-substituted alkyl group having a carbon atom number of 1-10, an alkoxy group having a carbon atom number of 1-10, a fluorine-substituted alkoxy group having a carbon atom number of 1-10, an alkenyl group having a carbon atom number of 2-10, a fluorine-substituted alkenyl group having a carbon atom number of 2-10, an alkenoxy group having a carbon atom number of 3-8 or an fluorine-substituted alkenoxy group having a carbon atom number of 3-8, wherein any one or more CH₂ in the groups represented by R₅ and R₆ is optionally replaced by cyclopentyl, cyclobutyl or cyclopropyl.

In one aspect, in one embodiment of the liquid crystal composition of the present invention, the above-mentioned one or more compounds represented by formula IV are selected from the group consisting of compounds represented by formulas IV2, IV6 and IV7 mentioned above.

In one aspect, in one embodiment of the liquid crystal composition of the present invention, the total content of the above-mentioned one or more compounds represented by formula IV is 1%-50% by mass, or may also be 10%-50% by mass;

In one aspect, in one embodiment of the liquid crystal composition of the present invention, it further comprises one or more compounds represented by general formula V:

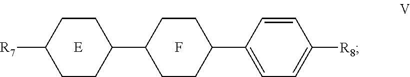

R₇ and R₈ each independently represent an alkyl group having a carbon atom number of 1-10, a fluorine-substituted alkyl group having a carbon atom number of 1-10, an alkoxy group having a carbon atom number of 1-10, a fluorine-substituted alkoxy group having a carbon atom number of 1-10, an alkenyl group having a carbon atom number of 2-10, a fluorine-substituted alkenyl group having a carbon atom number of 2-10, an alkenoxy group having a carbon atom number of 3-8 or an fluorine-substituted alkenoxy group having a carbon atom number of 3-8, wherein any one or more non-neighboring CH₂ in the groups represented by R₇ and R₈ are replaced by cyclopropyl; and

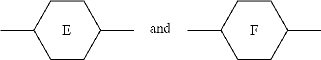

each independently represent 1,4-phenylene, a fluorine-substituted 1,4-phenylene, 1,4-cyclohexylene or 1,4-cyclohexenylene.

In one aspect, in one embodiment of the liquid crystal composition of the present invention, the above-mentioned one or more compounds represented by formula V may be selected from compounds represented by formulas V1 to V4:

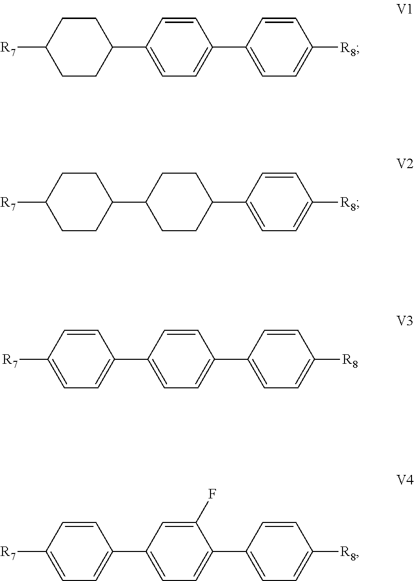

wherein R₇ and R₈ each independently represent an alkyl group having a carbon atom number of 1-10, a fluorine-substituted alkyl group having a carbon atom number of 1-10, an alkoxy group having a carbon atom number of 1-10, a fluorine-substituted alkoxy group having a carbon atom number of 1-10, an alkenyl group having a carbon atom number of 2-10, a fluorine-substituted alkenyl group having a carbon atom number of 2-10, an alkenoxy group having a carbon atom number of 3-8 or an fluorine-substituted alkenoxy group having a carbon atom number of 3-8, wherein any one or more non-neighboring CH₂ in the groups represented by R₇ and R₈ are replaced by cyclopropyl.

In one aspect, in one embodiment of the liquid crystal composition of the present invention, the above-mentioned one or more compounds represented by formula V are selected from the group consisting of compounds represented by formulas V1-1, V1-2, and V2-1:

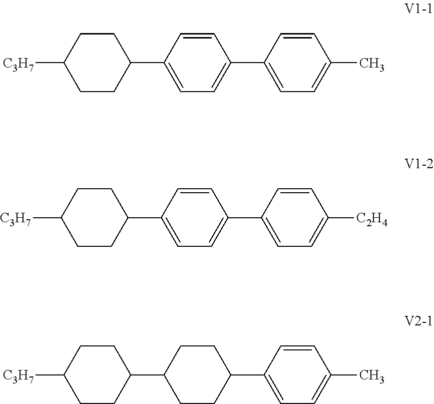

In one aspect, in one embodiment of the liquid crystal composition of the present invention, it further comprises one or more compounds represented by general formula VI:

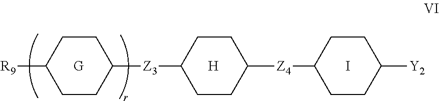

R₉ represents an alkyl group having a carbon atom number of 1-10, a fluorine-substituted alkyl group having a carbon atom number of 1-10, an alkoxy group having a carbon atom number of 1-10, a fluorine-substituted alkoxy group having a carbon atom number of 1-10, an alkenyl group having a carbon atom number of 2-10, a fluorine-substituted alkenyl group having a carbon atom number of 2-10, an alkenoxy group having a carbon atom number of 3-8 or an fluorine-substituted alkenoxy group having a carbon atom number of 3-8, wherein any one or more CH₂ in R₉ are optionally substituted with cyclopentyl, cyclobutyl or cyclopropyl;

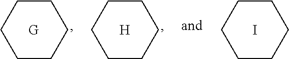

each independently represent:

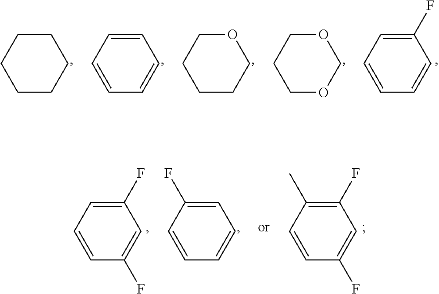

r represents 0, 1, 2 or 3;

Z₃ and Z₄ each independently represent a single bond, —CF₂O—, —CH₂CH₂—, or —CH₂O—; and

Y₂ represents F, a fluorine-substituted alkyl group having a carbon atom number of 1-5, a fluorine-substituted alkoxy group having a carbon atom number of 1-5, a fluorine-substituted alkenyl group having a carbon atom number of 2-5, or a fluorine-substituted alkenoxy group having a carbon atom number of 3-8.

In one aspect, in one embodiment of the liquid crystal composition of the present invention, the above-mentioned one or more compounds represented by formula VI are selected from the group consisting of compounds represented by formulas VI0 to VI26:

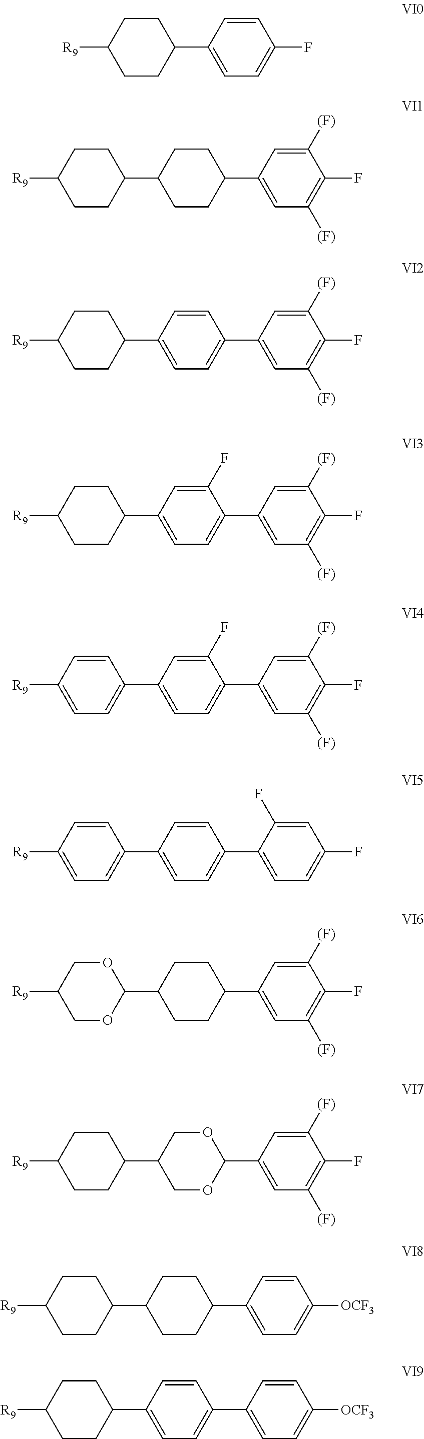

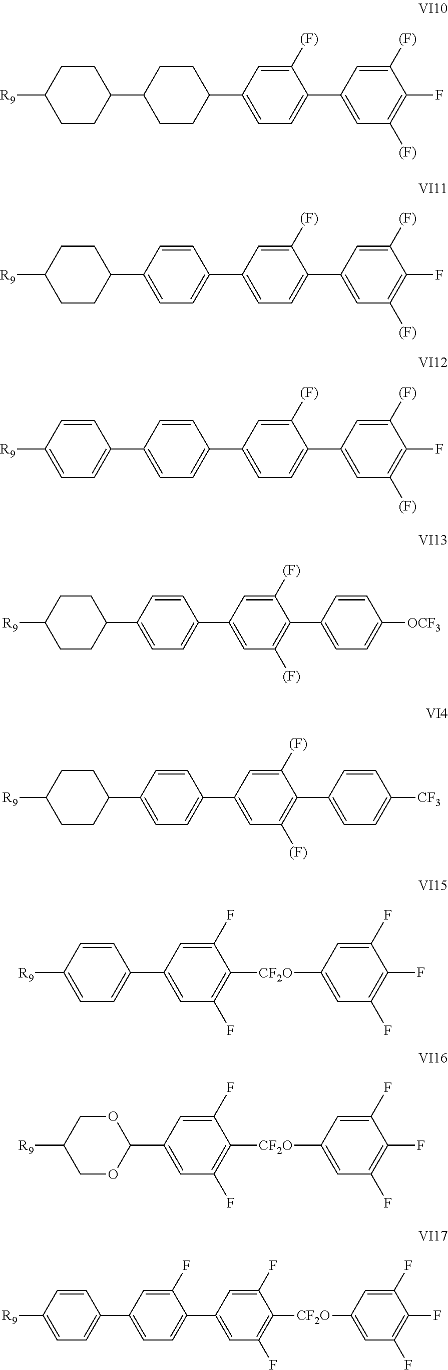

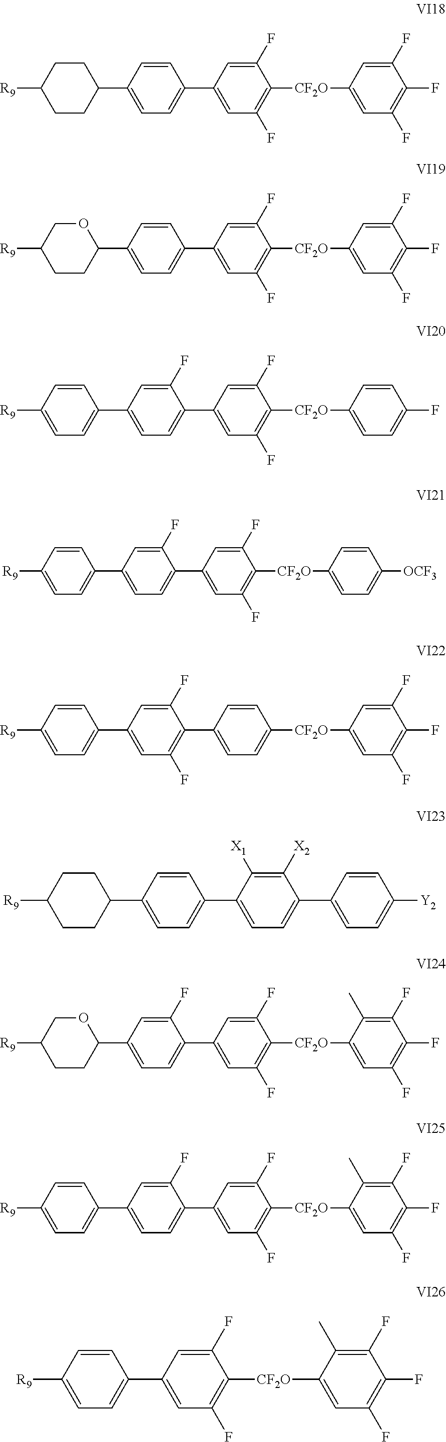

wherein

R₉ represents an alkyl group having a carbon atom number of 1-10, a fluorine-substituted alkyl group having a carbon atom number of 1-10, an alkoxy group having a carbon atom number of 1-10, a fluorine-substituted alkoxy group having a carbon atom number of 1-10, an alkenyl group having a carbon atom number of 2-10, a fluorine-substituted alkenyl group having a carbon atom number of 2-10, an alkenoxy group having a carbon atom number of 3-8 or an fluorine-substituted alkenoxy group having a carbon atom number of 3-8, wherein any one or more CH₂ in R₉ are optionally substituted with cyclopentyl, cyclobutyl or cyclopropyl;

(F) represents H or F; and

in formula VI23, X₁ and X₂ each independently represents H or F, Y₂ represents F, a fluorine-substituted alkyl group having a carbon atom number of 1-5, a fluorine-substituted alkoxy group having a carbon atom number of 1-5, a fluorine-substituted alkenyl group having a carbon atom number of 2-5, or a fluorine-substituted alkenoxy group having a carbon atom number of 3-8.

In one aspect, in the liquid crystal composition of the present invention, the above-mentioned one or more compounds represented by formula VI are selected from the group consisting of compounds represented by formulas VI24 to VI26 mentioned above.

In one aspect, in one embodiment of the liquid crystal composition of the present invention, it further comprises one or more compounds as shown below:

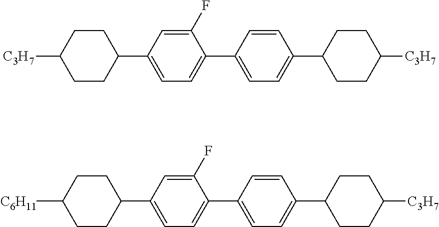

In one aspect, the present invention relates to a liquid crystal display element or liquid crystal display comprising the above-mentioned liquid crystal composition, which is an active matrix liquid crystal display element or liquid crystal display, or a passive matrix liquid crystal display element or liquid crystal display.

In one aspect, in one embodiment of the liquid crystal display element or liquid crystal display of the present invention, the liquid crystal display element or liquid crystal display may be any one of TN, ECB, VA, IPS, FFS, PS-TN, PS-VA, PS-IPS, PS-FFS, PA-VA, PA-IPS, PA-FFS, PI-less VA, PI-less IPS, and PI-less-FFS LCD modes.

As compared with the prior art, the beneficial effects of the present invention has lie in that the liquid crystal composition has a good stability to light and heat, a lower viscosity, a wider refractive index, a higher clearing point (a very wide service temperature range), and a high light transmittance; and the liquid crystal display element or display comprising the above-mentioned liquid crystal composition has the characteristics of a higher brightness and energy saving.

### DETAILED DESCRIPTION OF EMBODIMENTS

The present invention is further described in conjunction with particular examples below, but is not limited to the following examples. The methods described hereinafter are conventional methods unless otherwise specified. The raw materials described hereinafter can all be obtained from public commercial approaches unless otherwise specified.

The progress of a reaction is generally monitored by means of TLC during the reaction, and the post-treatment after the reaction is complete generally involves washing with water, extraction, combining and then drying organic phases, and reduced pressure distillation to remove a solvent, as well as recrystallization and column chromatography; a person skilled in the art would be able to implement the present invention according to the following description.

In the present specification, the percentages are mass percentages, the temperatures are in degree Celsius (° C.), and the specific meanings of other symbols and the test conditions are as follows:

Cp represents the clearing point (° C.) of a liquid crystal as measured by means of a DSC quantitative method;

Δn represents optical anisotropy, nₒ is the refractive index of an ordinary light, nₑ is the refractive index of an extraordinary light, with the test conditions being: 25±2° C., 589 nm and using an abbe refractometer for testing;

Δε represents dielectric anisotropy, with Δε=ε_{//}−ε_{⊥}, in which ε_{//} is a dielectric constant parallel to a molecular axis, and ε_{⊥} is a dielectric constant perpendicular to the molecular axis, with the test conditions being 25±0.5° C., a 20 micron parallel cell, and INSTEC: ALCT-IR1 for testing;

γ1 represents a rotary viscosity (mPa·s), with the test conditions being 25±0.5° C., a 20 micron parallel cell, and INSTEC: ALCT-IR1 for testing; and

T (%) represents transmittance, with T (%)=100%*bright state (Vop) luminance/light source luminance, with the test instrument being DMS501, and the test conditions being: 25±0.5° C., a test cell that is a 3.3 micron IPS test cell, an electrode spacing and an electrode width, both of which are 10 microns, and an included angle between the frictional direction and the electrode of 10°; since ε_{⊥} has a positive correlation with T, when considering the transmittance, ε_{⊥} can be used as an indicator to testify.

In the examples of the present invention, liquid crystal monomer structures are represented by codes, and the codes for ring structures, end groups and linking groups of liquid crystals are represented in Tables (I) and (II) below.

TABLE (I)
Codes corresponding to ring structures

| Ring structure | Corresponding code |
|---|---|
| 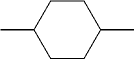 | C |
| 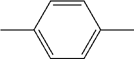 | P |
| 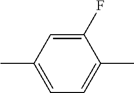 | G |
| 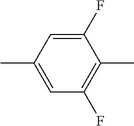 | U |
| 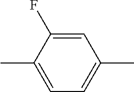 | GI |
| 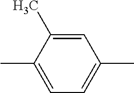 | P(2M) |
| 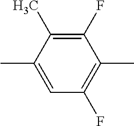 | U(2M) |
| 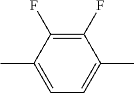 | Y |
| 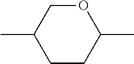 | A |
| 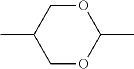 | D |
| 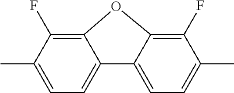 | B |
| 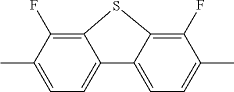 | B(S) |

TABLE (II)
Codes corresponding to end groups and linking groups

| End group and linking group | Corresponding code |
|---|---|
| CₙH₂ₙ₊₁— | n- |
| CₙH₂ₙ₊₁O— | nO— |
| —OCF₃ | OT |
| —CF₃ | -T |
| —CF₂O— | Q |
| —F | —F |
| —CN | —N |
| —CH₂CH₂— | E |
| —CH═CH— | V |
| —C≡C— | T |
| —COO— | Z |
| —CH═CH—CnH2n + 1 | —Vn |
| 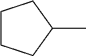 | C(5) |
| 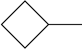 | C(4) |
| 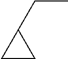 | C(3)1 |

### EXAMPLES

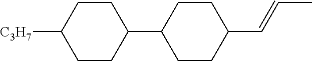

represents CC-3-V1,

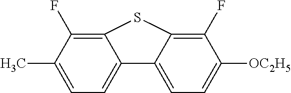 [SMILES: CCOc1ccc2c(sc3c(F)c(C)ccc32)c1F]

represents B(S)-1-O2

The following list involves the formulations and basic optical parameters of comparative liquid crystal compositions and 6 liquid crystal compositions:

### Comparative Example 1

| Category | Liquid crystal monomer code | Content (%) |
|---|---|---|
| V | CCP-3-5 | 5 |
| V | CCP-3-1 | 2 |
| V | CPP-2-3 | 2 |
| V | PGP-3-2 | 1 |
| IV | C1OY-3-O2 | 10 |
| IV | CY-3-O2 | 10 |
| IV | CPY-3-O2 | 5 |
| IV | PYP-2-3 | 5 |
| IV | CCY-3-O2 | 5 |
| IV | CC1OY-3-O2 | 5 |
| I | CC-3-V | 30 |
| I | CC-3-2 | 2 |
| I | CC-3-V1 | 2 |
| I | CC-5-V | 1 |
| I | CP-3-O2 | 2 |
| I | PP-1-5 | 2 |
| I | PP-5-O2 | 1 |
| II | B(S)-C(5)1O-O3 | 5 |
| II | B(S)-C(3)1O-O4 | 2 |
| II | B(S)-C(5)1O-O2 | 3 |

Δn [589 nm, 20° C.]: 0.0981
Cp [° C.]: 85
Δε [1 KHz, 20° C.]: −3.521
γ₁ [mPa · s, 20° C.]: 77.5449
Tr: 5.4%

| Category | Liquid crystal monomer code | Content (%) |
|---|---|---|
| V | CCP-3-5 | 5 |
| V | CCP-3-1 | 2 |
| V | CPP-2-3 | 2 |
| V | PGP-3-2 | 1 |
| IV | C1OY-3-O2 | 10 |
| IV | CY-3-O2 | 10 |
| IV | CPY-3-O2 | 5 |
| IV | PYP-2-3 | 5 |
| IV | CCY-3-O2 | 5 |
| IV | CC1OY-3-O2 | 5 |
| I | CC-3-V | 30 |
| I | CC-3-2 | 2 |
| I | CC-3-V1 | 2 |
| I | CC-5-V | 1 |
| I | CP-3-O2 | 2 |
| I | PP-1-5 | 2 |
| I | PP-5-O2 | 1 |
| III | B-C(5)1O-O2 | 5 |
| III | B-C(5)1O-O4 | 2 |
| III | B-C(3)1O-O5 | 3 |

Δn [589 nm, 20° C.]: 0.0963
Cp [° C.]: 83
Δε [1 KHz, 20° C.]: −3.579
γ₁ [mPa · s, 20° C.]: 73.9713
Tr: 5.3%

| Category | Liquid crystal monomer code | Content (%) |
|---|---|---|
| V | CCP-3-5 | 5 |
| V | CCP-3-1 | 2 |
| V | CPP-2-3 | 2 |
| V | PGP-3-2 | 1 |
| IV | C1OY-3-O2 | 10 |
| IV | CY-3-O2 | 10 |
| IV | CPY-3-O2 | 5 |
| IV | PYP-2-3 | 5 |
| IV | CCY-3-O2 | 5 |
| IV | CC1OY-3-O2 | 5 |
| I | CC-3-V | 30 |
| I | CC-3-2 | 2 |
| I | CC-3-V1 | 2 |
| I | CC-5-V | 1 |
| I | CP-3-O2 | 2 |
| I | PP-1-5 | 2 |
| I | PP-5-O2 | 1 |
| II | B(S)-C(5)1O-O3 | 3 |
| II | B(S)-C(3)1O-O4 | 2 |
| III | B-C(5)1O-O2 | 3 |
| III | B-C(5)1O-O4 | 2 |

Δn [589 nm, 20° C.]: 0.0972
Cp [° C.]: 84
Δε [1 KHz, 20° C.]: −3.55
γ₁ [mPa · s, 20° C.]: 70.5624
Tr: 6.0%

The liquid crystal compositions provided by Comparative Examples 1 and 2 and the liquid crystal composition provided by Example 1 are respectively poured into test cells and tested, giving the following results: the transmittance of the liquid crystal composition of Comparative Example 1 is 5.4%, the transmittance of the liquid crystal composition of Comparative Example 2 is 5.3%, and the transmittance of the liquid crystal composition of Example 1 is 6%, which is increased respectively by 11% and 13% with respect to the liquid crystal compositions of Comparative Examples 1 and 2. In addition, in the other aspects, the properties of clearing point, refractive index, dielectric, response time, etc. have no loss, so that a liquid crystal product having a fast response, a high transmittance and a good stability is obtained.

### Example 2

| Category | Liquid crystal monomer code | Content (%) |
|---|---|---|
| V | CCP-3-5 | 2 |
| V | CCP-3-1 | 1 |
| V | CPP-2-3 | 1 |
| V | PGP-3-2 | 1 |
| IV | CC1OY-3-O2 | 5 |
| IV | CCY-3-O2 | 2 |
| IV | C1OY-3-O2 | 3 |
| IV | CY-3-O2 | 3 |
| IV | CPY-C(3)-O2 | 2 |
| IV | PYP-2-3 | 3 |
| IV | PY-C(5)-O2 | 2 |
| IV | CPY-3-O2 | 5 |
| IV | PPY-2-3 | 5 |
| I | CC-3-V | 20 |
| I | CC-5-V | 5 |
| I | CC-2-3 | 5 |
| I | CC-3-5 | 2 |
| I | PP-5-O2 | 3 |
| I | CC-V-V1 | 3 |
| I | CC-3-V1 | 2 |
| I | PP-1-5 | 5 |
| III | B-C(3)1O-O4 | 5 |
| III | B-C(5)1O-O4 | 2 |
| III | B-C(4)1O-O5 | 3 |
| II | B(S)-C(3)1O-O5 | 5 |
| II | B(S)-C(5)1O-O4 | 3 |
| II | B(S)-C(5)1O-O2 | 2 |

Δn [589 nm, 20° C.]: 0.1121
Cp [° C.]: 83.5
Δε [1 KHz, 20° C.]: −3.6784
γ₁ [mPa · s, 20° C.]: 81.2455
Tr: 6.1%

The liquid crystal compositions provided by Comparative Examples 1 and 2 and the liquid crystal composition provided by Example 2 are respectively poured into test cells and tested, giving the following results: the transmittance of the liquid crystal composition of Comparative Example 1 is 5.4%, the transmittance of the liquid crystal composition of Comparative Example 2 is 5.3%, and the transmittance of the liquid crystal composition of Example 2 is 6.1%, which is increased respectively by 13% and 15% with respect to the liquid crystal compositions of Comparative Examples 1 and 2. Moreover, the liquid crystal composition of Example 2 has a larger refractive index, is suitable for display applications of low cell thickness, etc., and is advantageous for achieving a wide viewing angle, a high contrast, a high-quality dynamic picture play, etc.

### Example 3

| Category | Liquid crystal monomer code | Content (%) |
|---|---|---|
| V | PGP-3-5 | 5 |
| V | CCP-3-1 | 5 |
| V | CCP-3-5 | 2 |
| V | CPP-2-3 | 3 |
| IV | CC1OY-3-O2 | 2 |
| IV | CCY-3-O2 | 2 |
| IV | C1OY-3-O2 | 5 |
| IV | CY-3-O2 | 2 |
| IV | CPY-C(3)-O2 | 1 |
| IV | PYP-2-3 | 2 |
| IV | PY-C(5)-O2 | 1 |
| IV | CPY-3-O2 | 2 |
| IV | PPY-2-3 | 3 |
| I | CC-2-3 | 18 |
| I | CP-3-O2 | 2 |
| I | CC-3-V | 20 |
| I | CC-3-V1 | 10 |
| I | PP-1-5 | 5 |
| I | CC-3-5 | 5 |
| III | B-C(3)1O-O4 | 1 |
| III | B-C(5)1O-O4 | 1 |
| II | B(S)-C(3)1O-O5 | 1 |
| II | B(S)-C(5)1O-O4 | 1 |
| II | B(S)-C(5)1O-O2 | 1 |

Δn [589 nm, 20° C.]: 0.0931
Cp [° C.]: 85
Δε [1 KHz, 20° C.]: −2.4
γ₁ [mPa · s, 20° C.]: 53.3256
Tr: 6.2%

The liquid crystal compositions provided by Comparative Examples 1 and 2 and the liquid crystal composition provided by Example 3 are respectively poured into test cells and tested, giving the following results: the transmittance of the liquid crystal composition of Comparative Example 1 is 5.4%, the transmittance of the liquid crystal composition of Comparative Example 2 is 5.3%, and the transmittance of the liquid crystal composition of Example 3 is 6.2%, which is increased respectively by 15% and 17% with respect to the liquid crystal compositions of Comparative Examples 1 and 2. Moreover, the liquid crystal composition of Example 3 has a lower rotary viscosity and is suitable for liquid crystal displays with a high transmittance and a fast response.

### Example 4

| Category | Liquid crystal monomer code | Content (%) |
|---|---|---|
| V | CCP-3-5 | 5 |
| V | CCP-3-1 | 5 |
| V | CPP-2-3 | 5 |
| V | PGP-3-2 | 5 |
| IV | CC1OY-3-O2 | 5 |
| IV | CCY-3-O2 | 5 |
| IV | C1OY-3-O2 | 5 |
| IV | CY-3-O2 | 3 |
| IV | CPY-C(3)-O2 | 2 |
| IV | PYP-2-3 | 2 |
| IV | PY-3-O2 | 3 |
| IV | CPY-3-O2 | 2 |
| IV | PPY-2-3 | 3 |
| I | CC-3-V | 20 |
| I | CC-3-V1 | 10 |
| III | B-C(3)1O-O4 | 7 |
| III | B-C(3)1O-O5 | 7 |
| II | B(S)-C(3)1O-O5 | 1 |
| Other | CGPC-3-3 | 5 |

Δn [589 nm, 20° C.]: 0.1161
Cp [° C.]: 105
Δε [1 KHz, 20° C.]: −3.101
γ₁ [mPa · s, 20° C.]: 85
Tr: 6.1%

The liquid crystal compositions provided by Comparative Examples 1 and 2 and the liquid crystal composition provided by Example 4 are respectively poured into test cells and tested, giving the following results: the transmittance of the liquid crystal composition of Comparative Example 1 is 5.4%, the transmittance of the liquid crystal composition of Comparative Example 2 is 5.3%, and the transmittance of the liquid crystal composition of Example 4 is 6.1%, which is increased respectively by 13% and 15% with respect to the liquid crystal compositions of Comparative Examples 1 and 2. In addition, the liquid crystal composition of Example 4 has a larger refractive index, and a higher clearing point and transmittance. It is suitable for display applications of low cell thickness, etc., and has the display advantages of a high transmittance, a low power consumption and a good stability.

### Example 5

| Category | Liquid crystal monomer code | Content (%) |
|---|---|---|
| V | PGP-3-5 | 5 |
| V | CCP-3-1 | 10 |
| V | CPP-2-3 | 5 |
| IV | PY-3-O2 | 10 |
| IV | CY-3-O2 | 10 |
| IV | C1OY-3-O2 | 10 |
| I | CC-3-V | 20 |
| III | B-C(5)1O-O4 | 3 |
| III | B-C(3)1O-O5 | 7 |
| II | B(S)-C(3)1O-O5 | 5 |
| II | B(S)-C(5)1O-O4 | 5 |
| Other | CGPC-3-3 | 10 |

Δn [589 nm, 20° C.]: 0.1159
Cp [° C.]: 91
Δε [1 KHz, 20° C.]: −3.58
γ₁ [mPa · s, 20° C.]: 83
Tr: 6.3%

The liquid crystal compositions provided by Comparative Examples 1 and 2 and the liquid crystal composition provided by Example 5 are respectively poured into test cells and tested, giving the following results: the transmittance of the liquid crystal composition of Comparative Example 1 is 5.4%, the transmittance of the liquid crystal composition of Comparative Example 2 is 5.3%, and the transmittance of the liquid crystal composition of Example 5 is 6.3%, which is increased respectively by 16.6% and 18.8% with respect to the liquid crystal compositions of Comparative Examples 1 and 2. In addition, the liquid crystal composition of Example 5 has a larger refractive index, and a higher clearing point and transmittance. It is suitable for display applications of low cell thickness, etc., and has the display advantages of a high transmittance, a low power consumption and a good stability.

### Example 6

| Category | Liquid crystal monomer code | Content (%) |
|---|---|---|
| V | PGP-3-5 | 5 |
| V | CCP-3-1 | 5 |
| V | CPP-2-3 | 5 |
| VI | CP-3-F | 5 |
| VI | CCU-3-F | 5 |
| VI | CPU-3-F | 5 |
| VI | CGU-3-F | 1 |
| VI | PGU-3-F | 2 |
| VI | PGP-3-F | 2 |
| VI | CCP-3-OT | 5 |
| VI | CPGU-3-F | 1 |
| VI | PGUQU-3-F | 2 |
| VI | PGUQU-C(3)-F | 2 |
| VI | PGUQU-C(5)-F | 1 |
| VI | PGUQU(2M)-3-F | 2 |
| VI | PUQU-3-F | 2 |
| VI | PUQU(2M)-3-F | 1 |
| VI | PUQU-C(3)-F | 2 |
| VI | PUQU-C(5)-F | 2 |
| IV | PY-3-O2 | 1 |
| IV | CY-3-O2 | 2 |
| IV | CCY-3-O3 | 2 |
| IV | CC10Y-3-O2 | 2 |
| IV | C1OY-3-O2 | 2 |
| IV | CPY-3-O2 | 1 |
| I | CC-3-V | 20 |
| I | CC-3-V1 | 5 |
| I | PP-1-5 | 4 |
| III | B-C(5)1O-O4 | 2 |
| III | B-C(3)1O-O5 | 1 |
| II | B(S)-C(3)1O-O5 | 2 |
| II | B(S)-C(5)1O-O4 | 1 |

Δn [589 nm, 20° C.]: 0.1160
Cp [° C.]: 90
Δε [1 KHz, 20° C.]: 4.7421
γ₁ [mPa · s, 20° C.]: 71.6107
Tr: 6.0%

The liquid crystal compositions provided by Comparative Examples 1 and 2 and the liquid crystal composition provided by Example 6 are respectively poured into test cells and tested, giving the following results: the transmittance of the liquid crystal composition of Comparative Example 1 is 5.4%, the transmittance of the liquid crystal composition of Comparative Example 2 is 5.3%, and the transmittance of the liquid crystal composition of Example 6 is 6.0%, which is increased respectively by 11.1% and 13.2% with respect to the liquid crystal compositions of Comparative Examples 1 and 2. In addition, the liquid crystal composition of Example 6 has a larger refractive index, a higher clearing point, a greater dielectricity and transmittance, and a lower viscosity. It is suitable for display applications of a low cell thickness, a low power consumption, etc., and has the display advantages of a high display transmittance, a good display stability to light and heat, etc.

The liquid crystal composition of the present invention has a good stability to light and heat and a lower viscosity, can obtain a wider refractive index, a higher clearing point (a wide service temperature range), and especially has a higher light transmittance and a low threshold voltage. The liquid crystal display element or liquid crystal display using the liquid crystal composition of the present invention has a higher brightness or has an effect of saving energy and electricity.

1. A liquid crystal composition, comprising one or more compounds represented by formula I, one or more compounds represented by formula II, and one or more compounds represented by formula III: 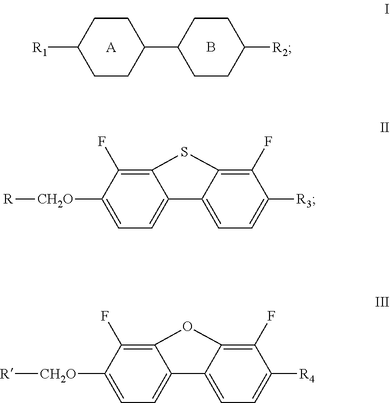
R₁, R₂, R₃ and R₄ each independently represent an alkyl group having a carbon atom number of 1-10, a fluorine-substituted alkyl group having a carbon atom number of 1-10, an alkoxy group having a carbon atom number of 1-10, a fluorine-substituted alkoxy group having a carbon atom number of 1-10, an alkenyl group having a carbon atom number of 2-10, a fluorine-substituted alkenyl group having a carbon atom number of 2-10, an alkenoxy group having a carbon atom number of 3-8 or an fluorine-substituted alkenoxy group having a carbon atom number of 3-8;
R and R′ represent cyclopropyl, cyclopentyl or 2-tetrahydrofuranyl; and
rings A and B each independently represent 1,4-phenylene or 1,4-cyclohexylene.

2. The liquid crystal composition according to claim 1, wherein said one or more compounds represented by formula I are selected from compounds represented by formulas I-1 to I-17 below, said one or more compounds represented by formula II are selected from compounds represented by formulas II-1 to II-3 below, and said one or more compounds represented by formula III are selected from compounds represented by formulas III-1 to III-3 below: 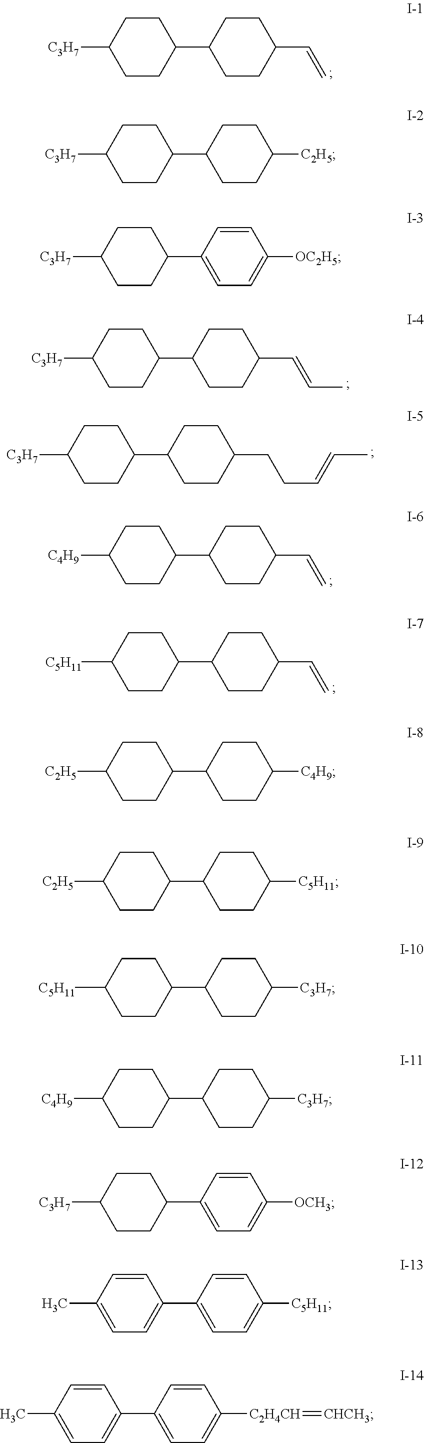 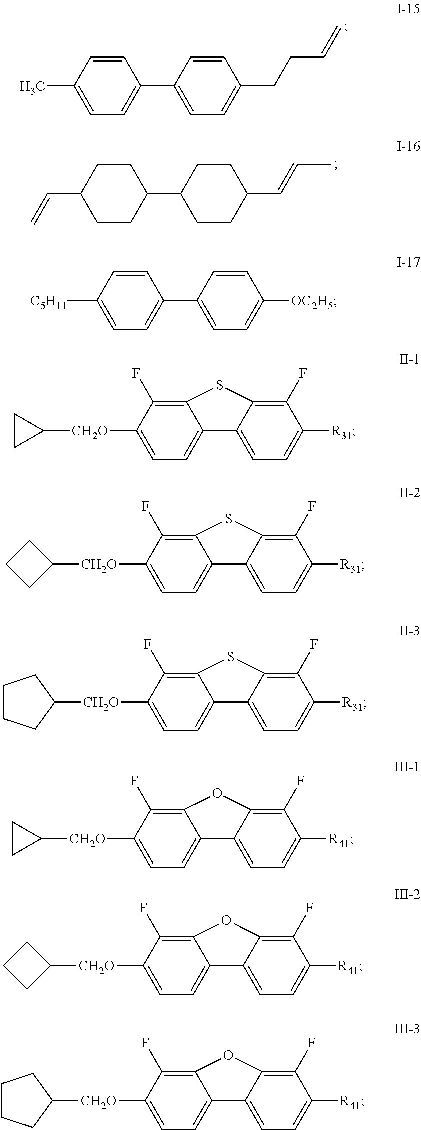
wherein
in formulas II-1 to II-3, R₃₁ represents an alkyl group having a carbon atom number of 1-10 or an alkoxy group having a carbon atom number of 1-10; and
in formulas III-1 to III-3, R₄₁ represents an alkyl group having a carbon atom number of 1-10 or an alkoxy group having a carbon atom number of 1-10.

3. The liquid crystal composition according to claim 1, wherein in said liquid crystal composition, the total content of the compound of formula I is from 5%-70% by mass, the total content of the compound of formula II is from 1%-15% by mass, and the total content of said one or more compounds represented by formula III is 1%-15% by mass.

4. The liquid crystal composition according to claim 1, wherein said liquid crystal composition further comprises one or more compounds represented by general formula IV: 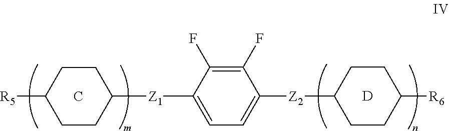
wherein R₅ and R₆ each independently represent an alkyl group having a carbon atom number of 1-10, fluorine, a fluorine-substituted alkyl group having a carbon atom number of 1-10, an alkoxy group having a carbon atom number of 1-10, a fluorine-substituted alkoxy group having a carbon atom number of 1-10, an alkenyl group having a carbon atom number of 2-10, a fluorine-substituted alkenyl group having a carbon atom number of 2-10, an alkenoxy group having a carbon atom number of 3-8 or an fluorine-substituted alkenoxy group having a carbon atom number of 3-8, wherein any one or more CH₂ in the groups represented by R₅ and R₆ is optionally replaced by cyclopentyl, cyclobutyl or cyclopropyl;
Z₁ and Z₂ each independently represent a single bond, —CH₂CH₂— or —CH₂O—; 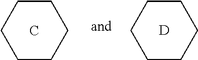
each independently represent 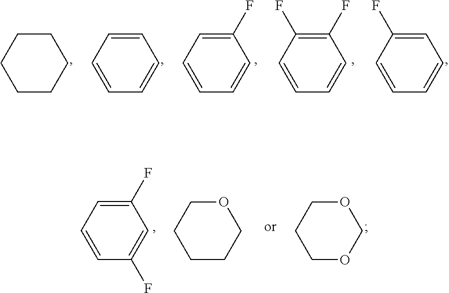
m represents 1, 2 or 3; and
n represents 0 or 1.

5. The liquid crystal composition according to claim 4, wherein said one or more compounds represented by formula IV are selected from the group consisting of compounds represented by formulas IV1 to IV13: 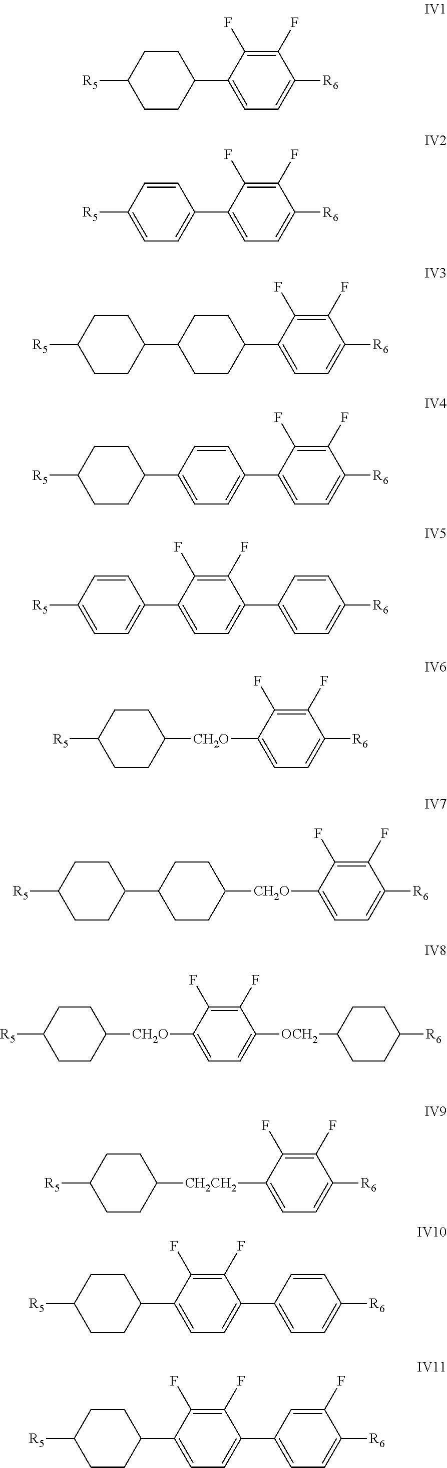 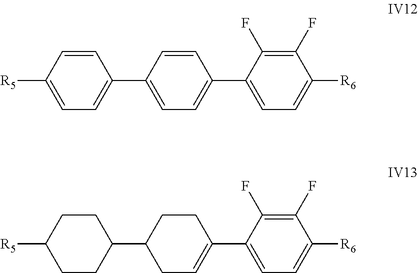
wherein R₅ and R₆ each independently represent an alkyl group having a carbon atom number of 1-10, fluorine, a fluorine-substituted alkyl group having a carbon atom number of 1-10, an alkoxy group having a carbon atom number of 1-10, a fluorine-substituted alkoxy group having a carbon atom number of 1-10, an alkenyl group having a carbon atom number of 2-10, a fluorine-substituted alkenyl group having a carbon atom number of 2-10, an alkenoxy group having a carbon atom number of 3-8 or an fluorine-substituted alkenoxy group having a carbon atom number of 3-8, wherein any one or more CH₂ in the groups represented by R₅ and R₆ is optionally replaced by cyclopentyl, cyclobutyl or cyclopropyl.

6. The liquid crystal composition according to claim 1, wherein said liquid crystal composition further comprises one or more compounds represented by general formula V: 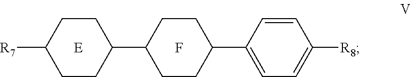
R₇ and R₈ each independently represent an alkyl group having a carbon atom number of 1-10, a fluorine-substituted alkyl group having a carbon atom number of 1-10, an alkoxy group having a carbon atom number of 1-10, a fluorine-substituted alkoxy group having a carbon atom number of 1-10, an alkenyl group having a carbon atom number of 2-10, a fluorine-substituted alkenyl group having a carbon atom number of 2-10, an alkenoxy group having a carbon atom number of 3-8 or an fluorine-substituted alkenoxy group having a carbon atom number of 3-8, wherein any one or more non-neighboring CH₂ in the groups represented by R₇ and R₈ are replaced by cyclopropyl; and 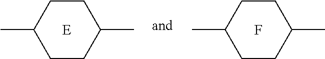
and each independently represent 1,4-phenylene, a fluorine-substituted 1,4-phenylene, 1,4-cyclohexylene or 1,4-cyclohexenylene.

7. The liquid crystal compound according to claim 6, wherein said one or more compounds represented by formula V may be selected from the group consisting of compounds represented by formulas V1 to V4: 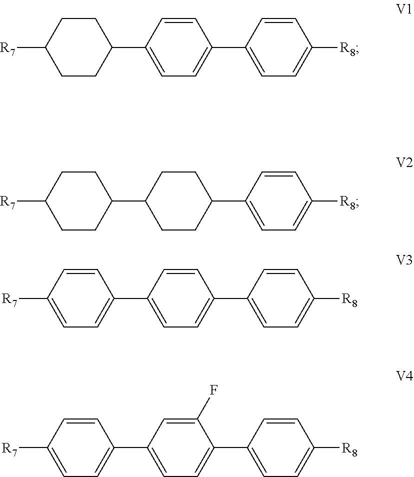
R₇ and R₈ each independently represent an alkyl group having a carbon atom number of 1-10, a fluorine-substituted alkyl group having a carbon atom number of 1-10, an alkoxy group having a carbon atom number of 1-10, a fluorine-substituted alkoxy group having a carbon atom number of 1-10, an alkenyl group having a carbon atom number of 2-10, a fluorine-substituted alkenyl group having a carbon atom number of 2-10, an alkenoxy group having a carbon atom number of 3-8 or an fluorine-substituted alkenoxy group having a carbon atom number of 3-8, wherein any one or more non-neighboring CH₂ in the groups represented by R₇ and R₈ are replaced by cyclopropyl.

8. The liquid crystal compound according to claim 1, wherein said liquid crystal composition further comprises one or more compounds represented by general formula VI: 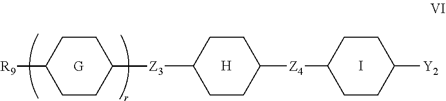
R₉ represents an alkyl group having a carbon atom number of 1-10, a fluorine-substituted alkyl group having a carbon atom number of 1-10, an alkoxy group having a carbon atom number of 1-10, a fluorine-substituted alkoxy group having a carbon atom number of 1-10, an alkenyl group having a carbon atom number of 2-10, a fluorine-substituted alkenyl group having a carbon atom number of 2-10, an alkenoxy group having a carbon atom number of 3-8 or an fluorine-substituted alkenoxy group having a carbon atom number of 3-8, wherein any one or more CH₂ in R₉ are optionally substituted with cyclopentyl, cyclobutyl or cyclopropyl; 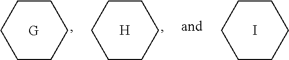
each independently represent: 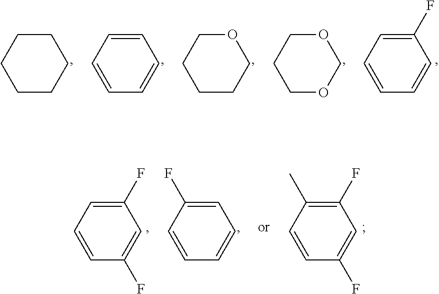
r represents 0, 1, 2 or 3;
Z₃ and Z₄ each independently represent a single bond, —CF₂O—, —CH₂CH₂—, or —CH₂O—; and
Y₂ represents fluorine, a fluorine-substituted alkyl group having a carbon atom number of 1-5, a fluorine-substituted alkoxy group having a carbon atom number of 1-5, a fluorine-substituted alkenyl group having a carbon atom number of 2-5, or a fluorine-substituted alkenoxy group having a carbon atom number of 3-8.

9. The liquid crystal compound according to claim 8, wherein said one or more compounds represented by formula VI are selected from the group consisting of compounds represented by formulas VI0 to VI26: 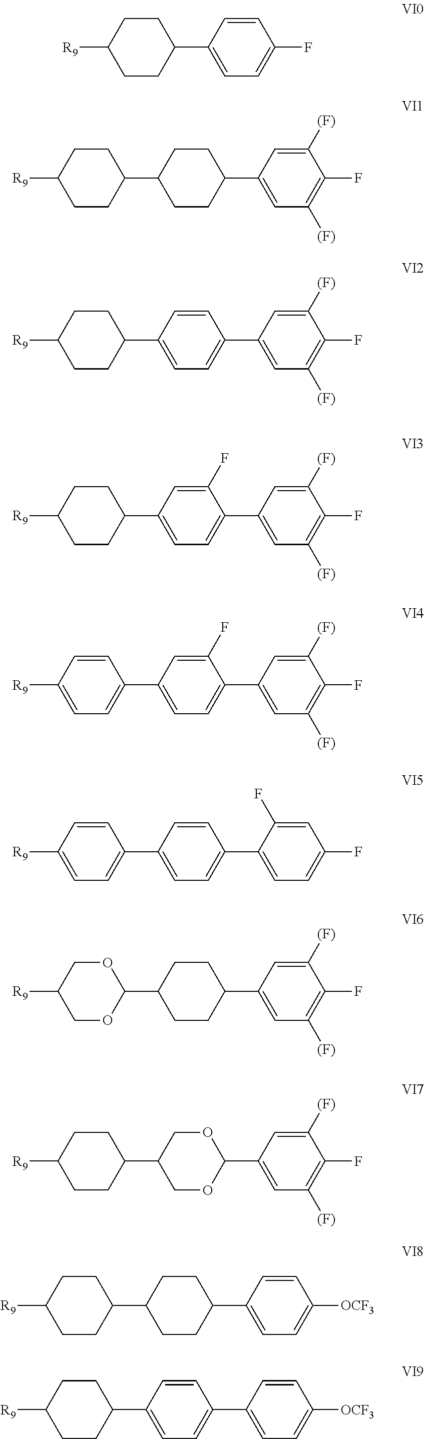 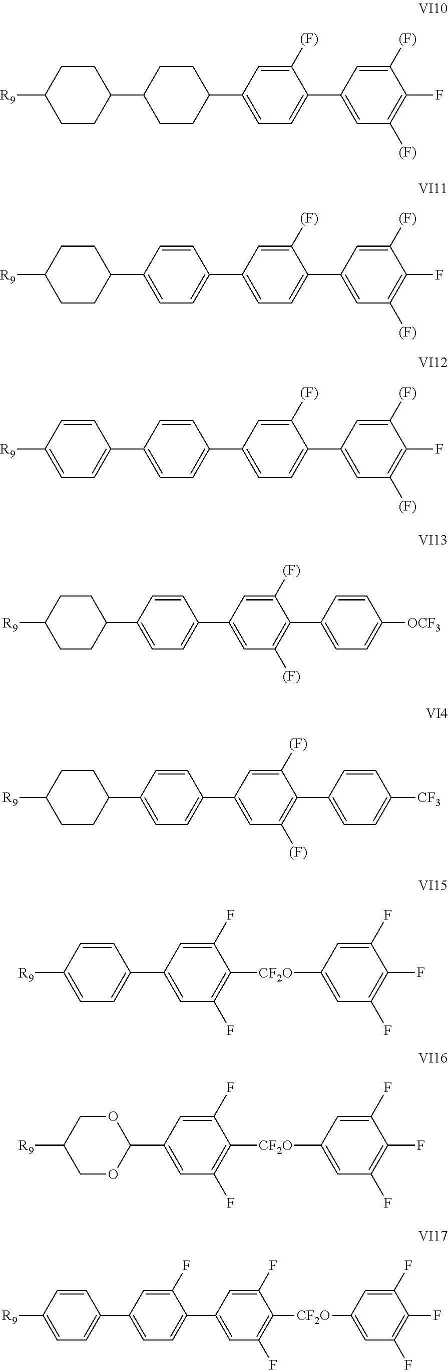 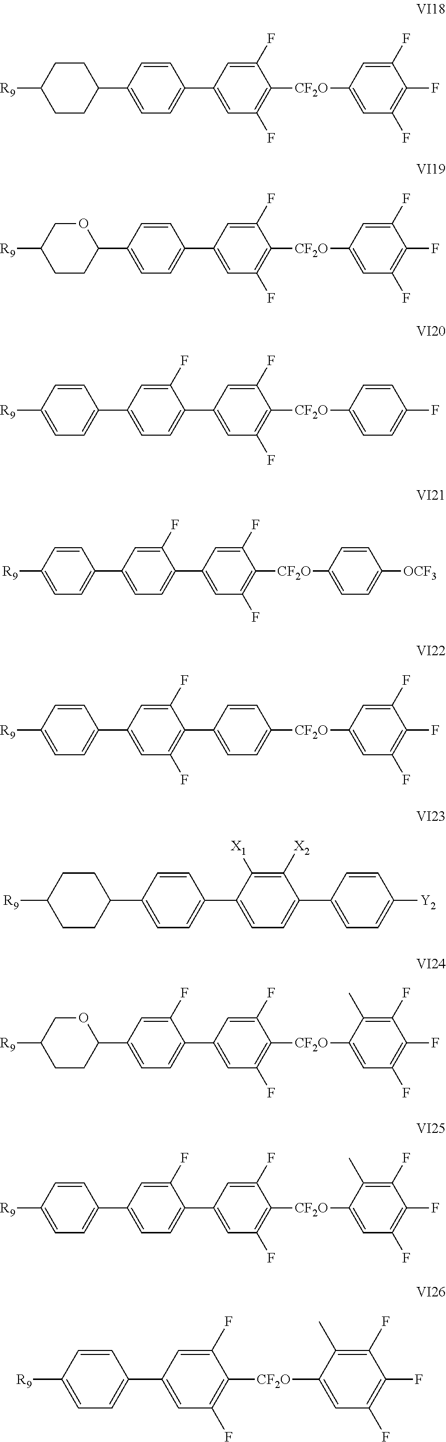
wherein
R₉ represents an alkyl group having a carbon atom number of 1-10, a fluorine-substituted alkyl group having a carbon atom number of 1-10, an alkoxy group having a carbon atom number of 1-10, a fluorine-substituted alkoxy group having a carbon atom number of 1-10, an alkenyl group having a carbon atom number of 2-10, a fluorine-substituted alkenyl group having a carbon atom number of 2-10, an alkenoxy group having a carbon atom number of 3-8 or an fluorine-substituted alkenoxy group having a carbon atom number of 3-8, wherein any one or more CH₂ in R₉ are optionally substituted with cyclopentyl, cyclobutyl or cyclopropyl;
(F) represents H or F; and
in formula VI23, X₁ and X₂ each independently represents H or F, Y₂ represents F, a fluorine-substituted alkyl group having a carbon atom number of 1-5, a fluorine-substituted alkoxy group having a carbon atom number of 1-5, a fluorine-substituted alkenyl group having a carbon atom number of 2-5, or a fluorine-substituted alkenoxy group having a carbon atom number of 3-8.

10. A liquid crystal display element or liquid crystal display comprising the liquid crystal composition of claim 1, said liquid crystal display element or liquid crystal display being an active matrix display element or display, or a passive matrix display element or display.
